(19) United States
(12) Patent Application Publication
(10) Pub. No.: US 2022/0198743 A1
(43) Pub. Date: Jun. 23, 2022

(54) METHOD FOR GENERATING LOCATION INFORMATION, RELATED APPARATUS AND COMPUTER PROGRAM PRODUCT

(71) Applicant: BEIJING BAIDU NETCOM SCIENCE TECHNOLOGY CO., LTD., Beijing (CN)

(72) Inventors: Zhaoliang Liu, Beijing (CN); Sili Chen, Beijing (CN); Yang Zhao, Beijing (CN)

(21) Appl. No.: 17/527,564

(22) Filed: Nov. 16, 2021

(30) Foreign Application Priority Data
Dec. 23, 2020 (CN) 202011545225.7

(51) Int. Cl. G06T 15/20; G06T 15/40; G06T 17/05; G06T 7/246

(52) U.S. Cl. CPC G06T 15/205; G06T 15/40; G06T 2207/30232; G06T 7/246; G06T 2207/10004; G06T 17/05

(57) ABSTRACT

A method and apparatus for generating location information, an electronic device, and a computer readable storage medium are provided. The method may include: constructing a corresponding plane equation based on three-dimensional space coordinates of a matching feature pair of a target plane object included in a pair of adjacent image frames having a frame interval less than a preset interval; merging identical plane equations in generated plane equations to obtain a target plane equation, and finally calculating to obtain real corner coordinates of the target plane object, based on corner theoretical coordinates of a graphic box on a plane corresponding to the target plane equation and gravity information of the target plane object.

### CROSS-REFERENCE TO RELATED APPLICATIONS

This application claims priority to Chinese Application No. 202011545225.7, filed on Dec. 23, 2020 and entitled “Method for Generating Location Information, Related Apparatus and Computer Program Product,” which is hereby incorporated by reference in its entirety.

### TECHNICAL FIELD

Embodiments of the present disclosure relate to the field of artificial intelligence technology, specifically to the fields of computer vision, image processing and augmented reality technology, and more specifically to a method and apparatus for generating location information, an electronic device, a computer readable storage medium, and a computer program product.

### BACKGROUND

In indoor scenarios of modern buildings such as shopping malls, teaching buildings, or office buildings, there are a large number outstanding objects that are flat and rectangular in shape, such as posters, pictorial posters. In order to improve the positioning or navigation accuracy when an indoor GPS signal is poor, these objects are generally used as references to complete positioning.

In the existing technology, generally, after extracting a visual feature from each image and matching features within graphic boxes in different images, triangulation is used to calculate three-dimensional coordinates of feature points in the plane graphic boxes based on matching results, and these three-dimensional coordinates are used to fit the plane where the graphic boxes are located, and finally the three-dimensional coordinates of the graphic boxes are calculated based on the fitted plane and inputted two-dimensional coordinates of corners of the graphic boxes.

### SUMMARY

Embodiments of the present disclosure propose a method and apparatus for generating location information, an electronic device and a computer readable storage medium.

In a first aspect, an embodiment of the present disclosure provides a method for generating location information, the method including: constructing a corresponding plane equation based on three-dimensional space coordinates of a matching feature pair of a target plane object included in a pair of adjacent image frames; the target plane object being framed by an identical graphic box in any frame of the adjacent image frames, and the pair of adjacent image frames being a pair of image frames having a frame interval less than a preset interval; merging, in response to existence of at least two identical plane equations, the at least two identical plane equations to obtain a target plane equation; and calculating to obtain real corner coordinates of the target plane object, based on corner theoretical coordinates of the graphic box on a plane corresponding to the target plane equation and gravity information of the target plane object.

In a second aspect, an embodiment of the present disclosure provides an apparatus for generating location information, the apparatus including: a plane equation generation unit, configured to construct a corresponding plane equation based on three-dimensional space coordinates of a matching feature pair of a target plane object included in a pair of adjacent image frames; the target plane object being framed by an identical graphic box in any frame of the adjacent image frames, and the pair of adjacent image frames being a pair of image frames having a frame interval less than a preset interval; a target plane equation generation unit, configured to merge, in response to existence of at least two identical plane equations, the at least two identical plane equations to obtain a target plane equation; and a location information calculation unit, configured to calculate to obtain real corner coordinates of the target plane object, based on corner theoretical coordinates of the graphic box on a plane corresponding to the target plane equation and gravity information of the target plane object.

In a third aspect, an embodiment of the present disclosure provides an electronic device, the device electronic including: at least one processor; and a memory, communicatively connected with the at least one processor; the memory storing instructions executable by the at least one processor, and the instructions, when executed by the at least one processor, causing the at least one processor to perform the method for generating location information according to any embodiment of the first aspect.

In a fourth aspect, an embodiment of the present disclosure provides a non-transitory computer readable storage medium, storing computer instructions, the computer instructions being used to cause a computer to perform the method for generating location information according to any embodiment of the first aspect.

In a fifth aspect, an embodiment of the present disclosure provides a computer program product, including a computer program, the computer program, when executed by a processor, performing the method for generating location information according to any embodiment of the first aspect.

It should be understood that the content described in this section is not intended to identify key or important features of embodiments of the present disclosure, nor is it intended to limit the scope of embodiments of the present disclosure. Other features of embodiments of the present disclosure may be easily understood by the following description.

### BRIEF DESCRIPTION OF THE DRAWINGS

By reading detailed description of non-limiting embodiments with reference to the following accompanying drawings, other features, objectives and advantages of the present disclosure will become more apparent.

FIG. 1 is an example system architecture in which embodiments of the present disclosure may be implemented;

FIG. 2 is a flowchart of a method for generating location information provided by an embodiment of the present disclosure;

FIG. 3 is a flowchart of acquiring gravity information in a method for generating location information provided by an embodiment of the present disclosure;

FIG. 4 is a flowchart of another method for generating location information provided by an embodiment of the present disclosure;

FIG. 5 is an effect schematic diagram of the method for generating location information in an application scenario provided by an embodiment of the present disclosure;

FIG. 6 is a structural block diagram of an apparatus for generating location information provided by an embodiment of the present disclosure; and

FIG. 7 is a schematic structural diagram of an electronic device for performing a method for generating location information provided by an embodiment of the present disclosure.

### DETAILED DESCRIPTION OF EMBODIMENTS

Embodiments of the present disclosure will be further described below in detail in combination with the accompanying drawings. It should be appreciated that embodiments described herein are merely used for explaining the relevant disclosure, rather than limiting the disclosure. In addition, it should be noted that, for the ease of description, only the parts related to the relevant disclosure are shown in the accompanying drawings.

It should also be noted that some embodiments in the present disclosure and some features in the disclosure may be combined with each other on a non-conflict basis. Features of the present disclosure will be described below in detail with reference to the accompanying drawings and in combination with embodiments.

According to the method and apparatus for generating location information, the electronic device, the computer readable storage medium and the computer program product provided by embodiments of the present disclosure, a corresponding plane equation is constructed based on three-dimensional space coordinates of a matching feature pair of a target plane object included in a pair of adjacent image frames having a frame interval less than a preset interval, identical plane equations in generated plane equations are merged to obtain a target plane equation, and finally real corner coordinates of the target plane object are calculated and obtained based on corner theoretical coordinates of the graphic box on a plane corresponding to the target plane equation and gravity information of the target plane object.

The method of embodiments of the present disclosure may overcome the problems of long time consuming and reconstruction errors caused by mismatching in the method for generating location information from each image in the existing technology, and may not only accurately calculate the position of the corners of the graphic box in the three-dimensional space, but also accurately obtain a real three-dimensional position of a real plane object.

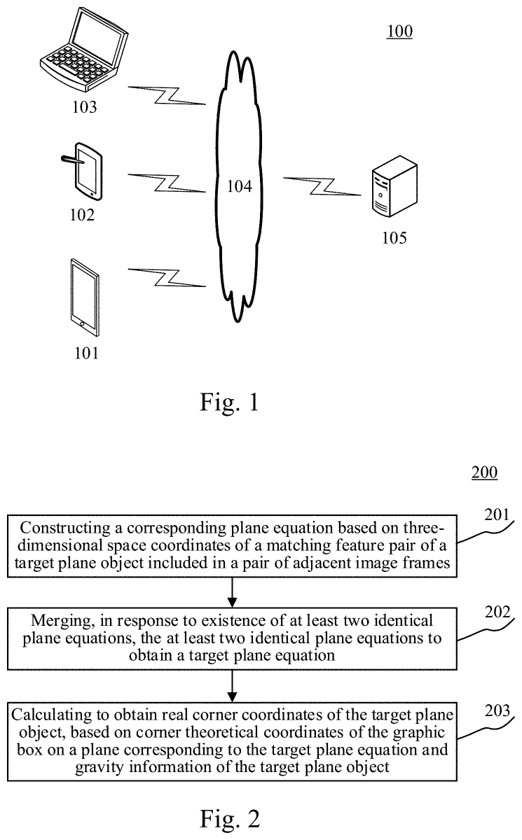

FIG. 1 shows an example system architecture 100 in which embodiments of a method and apparatus for generating location information, an electronic device, and a computer readable storage medium of the present disclosure may be implemented.

As shown in FIG. 1, the system architecture 100 may include terminal devices 101, 102, 103, a network 104, and a server 105. The network 104 serves as a medium for providing a communication link between the terminal devices 101, 102, 103 and the server 105. The network 104 may include various connection types, such as wired or wireless communication links, or optic fibers.

A user may use the terminal devices 101, 102, 103 to interact with the server 105 through the network 104 to send image frames, receive real corner coordinates of a target plane object, and so on. The terminal devices 101, 102, 103 and the server 105 may be installed with various applications related to acquiring real location information and scenario information between the terminal devices 101, 102, 103 and the server 105, such as map navigation applications, life recommendation applications, and virtual reality applications.

The terminal devices 101, 102, 103 and the server 105 may be hardware or software. When the terminal devices 101, 102, 103 are hardware, the terminal devices 101, 102, 103 may be various electronic devices having display screens, including but not limited to smart phones, tablet computers, laptop computers, desktop computers, etc.; when the terminal devices 101, 102, and 103 are software, the terminal devices 101, 102, 103 may be installed in the electronic devices listed above, which may be implemented as a plurality of pieces of software or software modules, or as a single piece of software or software module, which is not limited herein. When the server 105 is hardware, the server 105 may be implemented as a distributed server cluster composed of a plurality of servers, or as a single server; when the server is software, the server 105 may be implemented as a plurality of pieces of software or software modules, or as a single piece of software or software module, which is not limited herein.

The server 105 may provide various services through various built-in applications. Taking a map navigation application that may provide indoor route navigation as an example, the server 105 may realize the following effects when running the map navigation application: first, acquires a pair of image frames having a frame interval less than a preset interval from the terminal devices 101, 102, 103 through the network 104, and constructs a corresponding plane equation based on three-dimensional space coordinates of a matching feature pair of a target plane object included in a pair of adjacent image frames, where the target plane object is framed by an identical graphic box in any frame of the adjacent image frames; then, the server 105 merges, in response to existence of at least two identical plane equations, the at least two identical plane equations to obtain a target plane equation; and finally, the server 105 calculates to obtain real corner coordinates of the target plane object, based on corner theoretical coordinates of the graphic box on a plane corresponding to the target plane equation and gravity information of the target plane object.

It should be noted that, in addition to being acquired from the terminal devices 101, 102, 103 through the network 104, the pair of adjacent image frames may also be pre-stored locally in the server 105 in various methods. Therefore, when the server 105 detects that these data are already stored locally (for example, a to-be-processed location information generation task is stored before starting processing), the server 105 may choose to directly acquire these data locally. In this case, the example system architecture 100 may not include the terminal devices 101, 102, 103 and the network 104.

Since determining the real corner coordinates of the target plane object based on the pair of adjacent image frames requires more computing resources and strong computing power, the method for generating location information provided in embodiments of the present disclosure is generally performed by the server 105 having strong computing power and more computing resources. Correspondingly, the apparatus for generating location information is generally also provided in the server 105. However, it should also be noted that when the terminal devices 101, 102, and 103 also have computing power and computing resources that meet the requirements, the terminal devices 101, 102, and 103 may also use the map navigation application installed thereon to complete the above various calculations that are originally assigned to the server 105, and then output same results as the server 105. Especially when there are a plurality of terminal devices having different computing powers at the same time, when the map navigation application judges that the terminal device where it is located has strong computing power and more computing resources, the terminal device may perform the above calculations, thereby properly alleviating calculation pressure of the server 105. Correspondingly, the apparatus for generating location information may also be provided in the terminal devices 101, 102, 103. In this case, the example system architecture 100 may not include the server 105 and the network 104.

It should be understood that the numbers of terminal devices, networks and servers in FIG. 1 are merely illustrative. Depending on the implementation needs, there may be any number of terminal devices, networks and servers.

With further reference to FIG. 2, FIG. 2 is a flowchart of a method for generating location information provided by an embodiment of the present disclosure, where a flow 200 includes following steps.

Step 201, constructing a corresponding plane equation based on three-dimensional space coordinates of a matching feature pair of a target plane object included in a pair of adjacent image frames.

In the present embodiment, an executing body of the method for generating location information (for example, the server 105 shown in FIG. 1) acquires the pair of adjacent image frames, and constructs the corresponding plane equation based on the three-dimensional space coordinates of the matching feature pair of the target plane object included in the pair of adjacent image frames.

The adjacent image frames constituting the pair of adjacent image frames are a pair of image frames having a frame interval less than a preset interval in a same scenario image frame set. The scenario image frame set is composed of a plurality of consecutively shot image frames in the same scenario including the target plane object. After acquiring the pair of adjacent image frames, the matching feature pair including the target plane object may be extracted from the image frames.

The target plane object is framed by an identical graphic box in any frame of the adjacent image frames. The image frame may be determined by the executing body through image recognition, or may be manually determined by a user according to actual needs of the user. The graphic box is a graphic box with the smallest area that may completely frame the target plane object and is consistent with a plane shape of the target plane object.

It should be understood that because different image frames may have different shooting angles for the same target plane object, postures and sizes of the same plane object in the image frames may be different. A judgment criterion for the identical graphic box referred to in the present embodiment is whether the same target plane object is included, that is, graphic boxes that include the same target plane object at the same time are identical graphic boxes, and it is not required that a plurality of graphic boxes should have the same size or shape.

An image feature is extracted from each image frame, the specific image feature used is not limited in the present embodiment. It may be scale-invariant feature transform (SIFT), fast feature point extraction and description algorithm ORB (Oriented FAST and Rotated BRIEF, ORB for short) and other methods for extraction. The image features is composed of a corresponding feature vector and two-dimensional coordinates of feature points.

For a certain image frame, feature matching is performed with an image frame having a frame interval less than the preset interval in adjacent image frames.

For example, a feature in the M^{th} frame image and a feature in the (M−2)^{th} frame image are matched to obtain a feature matching relationship between the two frame images, the features that can be matched are called a matching feature pair. A process of the feature matching may be: calculating a distance between feature vectors; finding, if a distance between a feature F1 of an image M and a closest feature F2 in an image M−2 is D1, a distance between the feature F1 and a next closest feature F3 is D2, if D1/D2<TH1, it is considered that there is a matching image pair between F1 and F2, where TH1 is a preset threshold.

After the matching feature pair is determined, the three-dimensional space coordinates corresponding to the matching feature pair are acquired, to construct the corresponding plane equation.

For example, if the feature F1 in the image M and the feature F2 in the image M−2 are a matching feature pair, based on a 6-DOF (degree of freedom) pose of the image M, a 6-DOF pose of the image M−2, two-dimensional coordinates of the feature F1 in the image M and two-dimensional coordinates of the feature F2 in the image M−2, a triangulation method is used to calculate three-dimensional space coordinates of the F1 and the F2, and a corresponding plane equation is constructed based on the three-dimensional space coordinates of the F1 and the F2.

Step 202, merging, in response to existence of at least two identical plane equations, the at least two identical plane equations to obtain a target plane equation.

In the present embodiment, when it is determined that the plane equation determined based on the pair of adjacent image frames selected this time is identical to an existing plane equation in history, the identical plane equations are merged to obtain the target plane equation.

It should be understood that the plane equation is an equation formed corresponding to the target plane object. Because the selected pairs of adjacent image frames are different, and matching feature pairs determined from the pairs of adjacent image frames are different, there may be a plurality of plane equations that are similar in form but essentially the same, that is, the target plane equation where a plane object is located. In addition, since the adjacent image frames are a pair of image frames having the frame interval less than the preset interval in the same scenario image frame set, the scenario images contain the target plane object, there must be the target plane object in at least two different pairs of image frames at the same time. That is, different pairs of image frames may generate the plane equation of the plane where the target plane object is located. If the identical plane equations do not exist in the end, it may be correspondingly determined that the independent plane equation is incorrectly constructed, that is, the target plane object cannot be found in different pairs of adjacent image frames at the same time.

Step 203, calculating to obtain real corner coordinates of the target plane object, based on corner theoretical coordinates of the graphic box on a plane corresponding to the target plane equation and gravity information of the target plane object.

In the present embodiment, the corner theoretical coordinates of the graphic box on the plane are determined based on the target plane equation obtained in step 202, and a gravity direction of the target plane object is determined based on the gravity information of the target plane object, and a corresponding angle correction direction is determined. Then, the corner theoretical coordinates in a three-dimensional coordinate system are corrected based on the angle correction direction to obtain the real corner coordinates.

The method for generating location information according to an embodiment of the present disclosure may overcome the problems of long time consuming and reconstruction errors caused by mismatching in the method for generating location information from each image in the existing technology, and may not only accurately calculate the position of the corners of the graphic box in the three-dimensional space, but also accurately obtain a real three-dimensional position of a real plane object.

In some alternative implementations of the present embodiment, the merging, in response to existence of at least two identical plane equations, the at least two identical plane equations to obtain a target plane equation, includes: merging, in response to existence of at least two approximate plane equations pointing to a same plane at the same time, the approximate plane equations to obtain the only target plane equation.

To determine whether any two plane equations pointing to the same plane, normal vectors of planes corresponding to the two plane equations may be determined respectively, then an angle between the two normal vectors may be compared, and a distance between three-dimensional coordinates of two features in the matching feature pair may be acquired. When the angle between the normal vectors and the distance between the three-dimensional coordinates are less than predetermined threshold conditions, it is determined that the planes corresponding to the two plane equations are the same plane, that is, the two plane equations are approximate plane equations pointing to the same plane. The two approximate plane equations are merged to obtain the only target plane equation, so as to avoid too many plane equations to cause multiple repetitive calculations when generating the target plane equation, which affects the generation efficiency and wastes computing resources.

On this basis, in the process of merging the approximate plane equations, the matching feature pairs in the planes corresponding to the plane equations may also be verified. If the number of matching feature pairs that can meet a matching condition cannot meet the predetermined threshold conditions, it may be considered that the planes corresponding to the two plane equations are not the same plane, and merging of the plane equations is no longer performed to improve the accuracy of plane equation merging.

It should be understood that on this basis, a plurality of plane equations may also be judged based on the same principle to achieve a purpose of merging a plurality of approximate plane equations into the only plane equation, so as to further reduce the number of existing plane equations.

By merging the plane equations of the same plane into the only target plane equation, not only can the number of existing plane equations be reduced to achieve a purpose of simple calculation and resource saving, but also can further confirm whether the plane equations are for the plane where the target plane object is located, to improve the quality of the obtained plane equations.

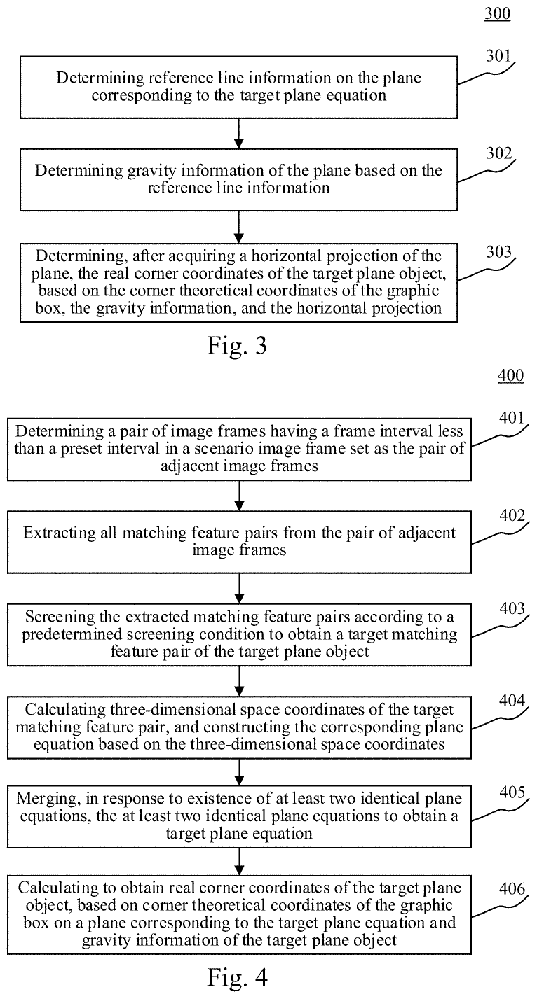

Further, in order to conveniently acquire the gravity information of the target plane object and improve the efficiency of determining the real corner coordinates, in some alternative implementations of the present embodiment, a specific implementation of step 203 may be referred to in a flow 300 as shown in FIG. 3, and includes following steps.

Step 301, determining reference line information on the plane corresponding to the target plane equation.

After acquiring the target plane equation, a graphic box that may be associated to the plane equation may be selected, then the reference line information may be determined by manual or image recognition on an image of the graphic box, and a pair of two-dimensional coordinates perpendicular to the ground direction may be generated. The reference line generally includes points on a straight line perpendicular to the ground (such as wall joints, a side of the target plane object perpendicular to the ground).

Step 302, determining gravity information of the plane based on the reference line information.

In each pair of two-dimensional coordinates generated in step 301, two three-dimensional space coordinates corresponding to the pair of two-dimensional coordinates are calculated based on the two-dimensional coordinates and the plane equation, and then the two three-dimensional coordinates are subtracted to obtain gravity direction information.

Step 303, determining, after acquiring a horizontal projection of the plane, the real corner coordinates of the target plane object, based on the corner theoretical coordinates of the graphic box, the gravity information, and the horizontal projection.

Based on the plane equation, the gravity direction is projected onto the plane, recorded as a gravity direction Y in the plane, a direction perpendicular to the direction Y in the plane is calculated and recorded as a horizontal direction X in the plane, and then projection coordinates of each feature in the X and Y directions are calculated, and maximum and minimum values of the projection coordinates in the X and Y directions are used as accurate coordinates of four corners of the graphic box in the plane equation, that is, the real corner coordinates of the target plane object.

With further reference to FIG. 4, FIG. 4 is a flowchart of another method for generating location information provided by an embodiment of the present disclosure, where a flow 400 includes the following steps.

Step 401, determining a pair of image frames having a frame interval less than a preset interval in a scenario image frame set as a pair of adjacent image frames.

In the present embodiment, the scenario image frame set is composed of a plurality of consecutively shot image frames for the same scenario. The number of image frames included in the image frame set may be obtained after setting a screening condition according to actual requirements. For example, it may be set that ten consecutive image frames shot for the same scenario are used for the scenario image frame set.

Step 402, extracting all matching feature pairs from the pair of adjacent image frames.

In the present embodiment, the pair of adjacent image frames is a pair of image frames having a frame interval less than the preset interval in a scenario image frame set determined in step 401, and then all the matching feature pairs are extracted from the pair of adjacent image frames. For the extraction process, reference may be made to the description of step 201 in the embodiment shown in FIG. 2, detailed description thereof will be omitted.

Step 403, screening the extracted matching feature pairs according to a predetermined screening condition to obtain a target matching feature pair of the target plane object.

In the present embodiment, the extracted matching feature pairs may be further screened according to the predetermined screening condition to ensure the quality of the generated target matching feature pair, and to prevent generation of wrong matching feature pairs and affect the quality of the generated plane equation, when the matching quality is poor.

Step 404, calculating three-dimensional space coordinates of the target matching feature pair, and constructing the corresponding plane equation based on the three-dimensional space coordinates.

Step 405, merging, in response to existence of at least two identical plane equations, the at least two identical plane equations to obtain a target plane equation.

Step 406, calculating to obtain real corner coordinates of the target plane object, based on corner theoretical coordinates of the graphic box on a plane corresponding to the target plane equation and gravity information of the target plane object.

The above steps 405-406 are the same as steps 202-203 shown in FIG. 2. For the same part of content, reference may be made to the corresponding part of the previous embodiment, and detailed description thereof will be omitted.

In the present embodiment, all the obtained matching feature pairs are further screened to ensure the quality of the generated target matching feature pair, and to prevent the generation of wrong matching feature pairs and affect the quality of the generated plane equation, when the matching quality is poor.

In some alternative implementations of the present embodiment, the screening the extracted matching feature pairs according to the predetermined screening condition to obtain the target matching feature pair of the target plane object, includes: deleting a matching feature pair meeting at least one of following conditions from the extracted matching feature pairs: not belonging to the target plane object, a reprojection error is less than a preset threshold condition, or not meeting homography; and determining a remaining matching feature pair as the target matching feature pair.

For a judgment method of whether the matching feature pair belongs to the plane object, for example, a feature F1 in an image M and a feature F2 in an image M−2 are a matching feature pair, if the feature F1 is located inside a graphic box A framing the target plane object in the image M, and the feature F2 is located inside a graphic box B framing the target plane object in the image M−2, then keep the matching feature pair, otherwise delete the matching feature pair.

For a judgment method of whether a reprojection error between a pair of matching features is less than a preset threshold condition, for example, if the feature F1 in the image M and the feature F2 in the image M−2 are a matching feature pair, based on a 6-DOF pose of the image M, a DOF pose of the image M−2, two-dimensional coordinates of the feature F1 and two-dimensional coordinates of the feature F2, a triangulation method is used to calculate three-dimensional space coordinates of the F1 and the F2 and a reprojection error of the space coordinates. If the reprojection error is greater than a preset threshold, it indicates that the feature F1 and the feature F2 are not the same point in space, then delete this matching feature pair.

For a judgment method of whether the matching feature pair meets homography, for example, it may be to find all matching feature pairs in the graphic box A framing the target plane object in the image M and the graphic box B framing the target plane object in the image M−2, and based on two-dimensional coordinates of this set of matching image pairs, calculate a homography matrix of the graphic box A framing the target plane object and the graphic box B framing the target plane object, and an interior point ratio of the homography matrix. If the interior point ratio is less than a preset threshold, it indicates that all matching features in the graphic box A framing the target plane object are not on the same plane, or all matching features in the graphic box B framing the target plane object are not on the same plane, that is, the extracted matching features of the graphic box A framing the target plane object do not meet planarity, or the matching features of the graphic box B framing the target plane object do not meet the planarity, in this regard, it is necessary to delete all the matching image pairs in the graphic box A framing the target plane object and the graphic box B framing the target plane object.

It should be understood that in the process of implementing screening of the matching feature pairs, the predetermined screening condition for the matching feature pairs may be selected and used individually, or combined with other method for multi-step screening. Considering that different computational complexity correspond to different screening conditions, an alternative screening process is from simple to complex, that is, to judge in an order of whether the matching feature pair belongs to the target plane object, whether the reprojection error is less than the preset threshold condition, and whether homography is met, so that on the basis of improving the quality of the acquired matching feature pairs, the screening efficiency for the matching feature pairs is improved.

Since the image frames in the pair of adjacent image frames may be used to generate a plurality of different pairs of adjacent image frames, a single image frame may have a plurality of plane equations. Therefore, when associating the graphic box in the image frame to a corresponding plane equation, there may be cases where the image frame has been associated to another plane equation. In order to avoid mismatching caused by this case, in some alternative implementations of the present embodiment, when associating the graphic box to the corresponding plane equation, the identical plane equations may be merged. The process is as follows.

The graphic box A framing the target plane object in the image M and the graphic box B framing the target plane object in the image M−2 are respectively associated to the same plane equation.

If A and B have not been associated to a plane equation, then A and B are directly associated to the currently determined plane equation.

If one graphic box of A and B has been associated to another plane equation, checking whether the other plane equation and the currently determined plane equation point to the same plane, if the other plane equation and the currently determined plane equation point to the same plane, then the current plane equation is merged into the other plane equation, and then the current plane equation is deleted, otherwise A and B are associated to the current plane equation respectively.

Approximately, if A has been associated to a plane equation P′ and B has been associated to a plane equation P″, then whether the current plane equation P and P′, P and P″ are the same plane are respectively checked, if both sides are the same plane, then the plane equations P′ and P″ are merged and the plane equation P is deleted, and A and B are respectively associated to a plane equation obtained by merging the plane equations P′ and P″; if only one side is the same plane, then the plane equation same as the plane equation P is merged, and A and B are respectively associated to the merged plane equation, if both sides are not the same plane, then A and B are associated to the current plane equation.

On the basis of this implementation, in order to further verify whether the finally obtained plane equation is a true and accurate plane equation of the plane where the target plane object is located, the number of identical graphic boxes associated to each of the plane equations may be acquired respectively to obtain a number of association. A final matching of different image frame pairs may be judged through the number of identical graphic boxes associated to each of the plane equations, and a plane equation having the number of association not meeting a preset threshold requirement may be deleted, so as to realize screening of the obtained plane equations.

It should be understood that the above identical graphic boxes refer to graphic boxes that frame the same target plane object, that is, the same target plane object is required to be framed in the graphic boxes. In practice, due to different shooting angles for the target plane object, there may be differences in shape and size of the graphic boxes in different image frames.

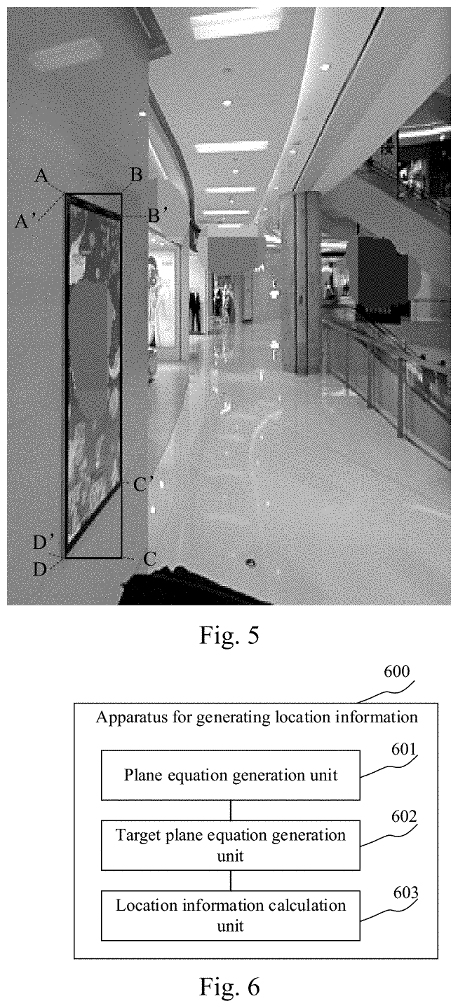

In order to deepen understanding, embodiments of the present disclosure also combine a specific application scenario and give a specific implementation solution. For convenience of description, it is combined with a scenario where a target plane object in an actual scenario is a “poster” for description. For a schematic diagram of the scenario, reference may be as shown in FIG. 5, and the implementation includes following steps.

First, inputting a graphic box ABCD of the target plane object, and then determining a scenario image frame set based on the plane object and the graphic box.

Secondly, constructing a corresponding plane equation based on three-dimensional space coordinates of a matching feature pair of the target plane object included in a pair of adjacent image frames in the scenario image frame set.

Then, merging, based on generated plane equations, identical plane equations to obtain a target plane equation.

Finally, calculating to obtain real corner A′B′C′D′ coordinates of the target plane object, based on corner theoretical coordinates of the graphic box on a plane corresponding to the target plane equation and gravity information of the target plane object.

With further reference to FIG. 6, as an implementation of the method shown in the above figures, an embodiment of the present disclosure provides an apparatus for generating location information. An embodiment of the apparatus may correspond to an embodiment of the method shown in FIG. 2, and the apparatus may be applied to various electronic devices.

As shown in FIG. 6, an apparatus 600 for generating location information of the present embodiment may include: a plane equation generation unit 601, a target plane equation generation unit 602 and a location information calculation unit 603. The plane equation generation unit 601 is configured to construct a corresponding plane equation based on three-dimensional space coordinates of a matching feature pair of a target plane object included in a pair of adjacent image frames; the target plane object being framed by an identical graphic box in any frame of the adjacent image frames, and the pair of adjacent image frames being a pair of image frames having a frame interval less than a preset interval. The target plane equation generation unit 602 is configured to merge, in response to existence of at least two identical plane equations, the at least two identical plane equations to obtain a target plane equation. The location information calculation unit 603 is configured to calculate to obtain real corner coordinates of the target plane object, based on corner theoretical coordinates of the graphic box on a plane corresponding to the target plane equation and gravity information of the target plane object.

In the present embodiment, for the specific processing and the technical effects of the plane equation generation unit 601, the target plane equation generation unit 602 and the location information calculation unit 603, reference may be made to the relevant description of steps 201-203 in the embodiment corresponding to FIG. 2 respectively, and detailed description thereof will be omitted.

In some alternative implementations of the present embodiment, the plane equation generation unit 602 includes: an image frame pair determination subunit, configured to determine the pair of image frames having the frame interval less than the preset interval in a scenario image frame set as the pair of adjacent image frames; a matching feature pair extraction subunit, configured to extract all matching feature pairs from the pair of adjacent image frames; a matching feature pair screening subunit, configured to screen the extracted matching feature pairs according to a predetermined screening condition to obtain a target matching feature pair of the target plane object; and a plane equation generation subunit, configured to calculate three-dimensional space coordinates of the target matching feature pair, and construct the corresponding plane equation based on the three-dimensional space coordinates.

In some alternative implementations of the present embodiment, the matching feature pair screening subunit includes: a matching feature pair deletion module, configured to delete a matching feature pair meeting at least one of following conditions from the extracted matching feature pairs: not belonging to the target plane object, a reprojection error is less than a preset threshold condition, or not meeting homography; and a matching feature pair determination module, configured to determine a remaining matching feature pair as the target matching feature pair.

In some alternative implementations of the present embodiment, the apparatus 600 for generating location information also includes: a plane equation association unit, configured to associate the graphic box to the corresponding plane equation; and a plane equation merging unit, configured to merge, in response to determining that a plurality of identical plane equations are associated to identical graphic boxes, the identical plane equations.

In some alternative implementations of the present embodiment, the apparatus 600 for generating location information also includes: a number of association acquisition unit, configured to acquire respectively a number of the identical graphic boxes associated to each of the plane equations to obtain a number of association; a plane equation deletion unit, configured to delete a plane equation having the number of association not meeting a preset threshold requirement.

In some alternative implementations of the present embodiment, the target plane equation generation unit 602 is further configured to: merge, in response to existence of at least two approximate plane equations pointing to a same plane at the same time, the approximate plane equations to obtain the only target plane equation.

In some alternative implementations of the present embodiment, the location information calculation unit 603 includes: a reference line determination subunit, configured to determine reference line information on the plane corresponding to the target plane equation; a gravity information calculation subunit, configured to determine gravity information of the plane based on the reference line information; and a real coordinate calculation subunit, configured to determine, after acquiring a horizontal projection of the plane, the real corner coordinates of the target plane object, based on the corner theoretical coordinates of the graphic box, the gravity information, and the horizontal projection.

The present embodiment serves as an apparatus embodiment corresponding to the foregoing method embodiment, the apparatus for generating location information provided by the present embodiment may overcome the problems of long time consuming and reconstruction errors caused by mismatching in the method for generating location information from each image in the existing technology, and may not only accurately calculate the position of the corners of the graphic box in the three-dimensional space, but also accurately obtain a real three-dimensional position of a real plane object.

According to an embodiment of the present disclosure, the present disclosure also provides an electronic device, a computer readable storage medium and a computer program product.

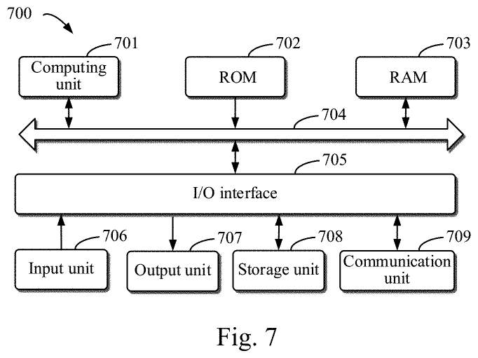

FIG. 7 shows a schematic block diagram of an example electronic device 700 that may be used to implement embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 7, the device 700 includes a computing unit 701, which may perform various appropriate actions and processing, based on a computer program stored in a read-only memory (ROM) 702 or a computer program loaded from a storage unit 708 into a random access memory (RAM) 703. In the RAM 703, various programs and data required for the operation of the device 700 may also be stored. The computing unit 701, the ROM 702, and the RAM 703 are connected to each other through a bus 704. An input/output (I/O) interface 705 is also connected to the bus 704.

A plurality of components in the device 700 are connected to the I/O interface 705, including: an input unit 706, for example, a keyboard and a mouse; an output unit 707, for example, various types of displays and speakers; the storage unit 708, for example, a disk and an optical disk; and a communication unit 709, for example, a network card, a modem, or a wireless communication transceiver. The communication unit 709 allows the device 700 to exchange information/data with other devices over a computer network such as the Internet and/or various telecommunication networks.

The computing unit 701 may be various general-purpose and/or dedicated processing components having processing and computing capabilities. Some examples of the computing unit 701 include, but are not limited to, central processing unit (CPU), graphics processing unit (GPU), various dedicated artificial intelligence (AI) computing chips, various computing units running machine learning model algorithms, digital signal processor (DSP), and any appropriate processors, controllers, microcontrollers, etc. The computing unit 701 performs the various methods and processes described above, such as the method for generating location information. For example, in some embodiments, the method for generating location information may be implemented as a computer software program, which is tangibly included in a machine readable medium, such as the storage unit 708. In some embodiments, part or all of the computer program may be loaded and/or installed on the device 700 via the ROM 702 and/or the communication unit 709. When the computer program is loaded into the RAM 703 and executed by the computing unit 701, one or more steps of the method for generating location information described above may be performed. Alternatively, in other embodiments, the computing unit 701 may be configured to perform the method for generating location information by any other appropriate means (for example, by means of firmware).

Various embodiments of the systems and technologies described in this article may be implemented in digital electronic circuit systems, integrated circuit systems, field programmable gate arrays (FPGA), application specific integrated circuits (ASIC), application-specific standard products (ASSP), system-on-chip (SOC), load programmable logic device (CPLD), computer hardware, firmware, software, and/or their combinations. These various embodiments may include: being implemented in one or more computer programs, the one or more computer programs may be executed and/or interpreted on a programmable system including at least one programmable processor, the programmable processor may be a dedicated or general-purpose programmable processor that may receive data and instructions from a storage system, at least one input apparatus, and at least one output apparatus, and transmit the data and instructions to the storage system, the at least one input apparatus, and the at least one output apparatus.

Program codes for implementing the method of embodiments of the present disclosure may be written in any combination of one or more programming languages. These program codes may be provided to a processor or controller of a general purpose computer, special purpose computer or other programmable data processing apparatus such that the program codes, when executed by the processor or controller, enables the functions/operations specified in the flowcharts and/or block diagrams being implemented. The program codes may execute entirely on the machine, partly on the machine, as a stand-alone software package partly on the machine and partly on the remote machine, or entirely on the remote machine or server.

In the context of the present disclosure, the machine readable medium may be a tangible medium that may contain or store programs for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, portable computer disk, hard disk, random access memory (RAM), read only memory (ROM), erasable programmable read only memory (EPROM or flash memory), optical fiber, portable compact disk read only memory (CD-ROM), optical storage device, magnetic storage device, or any suitable combination of the foregoing.

In order to provide interaction with a user, the systems and technologies described herein may be implemented on a computer, the computer has: a display apparatus for displaying information to the user (for example, CRT (cathode ray tube) or LCD (liquid crystal display) monitor); and a keyboard and a pointing apparatus (for example, mouse or trackball), and the user may use the keyboard and the pointing apparatus to provide input to the computer. Other types of apparatuses may also be used to provide interaction with the user; for example, feedback provided to the user may be any form of sensory feedback (for example, visual feedback, auditory feedback, or tactile feedback); and any form (including acoustic input, voice input, or tactile input) may be used to receive input from the user.

The systems and technologies described herein may be implemented in a computing system that includes backend components (e.g., as a data server), or a computing system that includes middleware components (e.g., application server), or a computing system that includes frontend components (for example, a user computer having a graphical user interface or a web browser, through which the user may interact with the implementations of the systems and the technologies described herein), or a computing system that includes any combination of such backend components, middleware components, or frontend components. The components of the system may be interconnected by any form or medium of digital data communication (e.g., communication network). Examples of the communication network include: local area networks (LAN), wide area networks (WAN), and the Internet.

The computer system may include a client and a server. The client and the server are generally far from each other and usually interact through the communication network. The relationship between the client and the server is generated by computer programs that run on the corresponding computer and have a client-server relationship with each other. The server may be a cloud server, also known as a cloud computing server or a cloud host, and is a host product in a cloud computing service system, so as to solve the defects of difficult management and weak service extendibility existing in conventional physical hosts and VPS services.

The technical solution according to embodiments of the present disclosure, may overcome the problems of long time consuming and reconstruction errors caused by mismatching in the method for generating location information from each image in the existing technology, and may not only accurately calculate the position of the corners of the graphic box in the three-dimensional space, but also accurately obtain a real three-dimensional position of a real plane object.

It should be understood that the various forms of processes shown above may be used to reorder, add, or delete steps. For example, the steps described in embodiments of the present disclosure may be performed in parallel, sequentially, or in different orders. As long as the desired results of the technical solution disclosed in the embodiments of present disclosure can be achieved, no limitation is made herein.

The above specific embodiments do not constitute limitation on the protection scope of the present disclosure. Those skilled in the art should understand that various modifications, combinations, sub-combinations and substitutions may be made according to design requirements and other factors. Any modification, equivalent replacement and improvement made within the spirit and principle of the present disclosure shall be included in the protection scope of the present disclosure.

What is claimed is:

1. A method for generating location information, the method comprising:
constructing a corresponding plane equation based on three-dimensional space coordinates of a matching feature pair of a target plane object included in a pair of adjacent image frames; the target plane object being framed by an identical graphic box in any frame of the adjacent image frames, and the pair of adjacent image frames being a pair of image frames having a frame interval less than a preset interval;
merging, in response to existence of at least two identical plane equations, the at least two identical plane equations to obtain a target plane equation; and
calculating to obtain real corner coordinates of the target plane object, based on corner theoretical coordinates of the graphic box on a plane corresponding to the target plane equation and gravity information of the target plane object.

2. The method according to claim 1, wherein the constructing the corresponding plane equation based on three-dimensional space coordinates of the matching feature pair of the target plane object included in the pair of adjacent image frames, comprises:
determining the pair of image frames having the frame interval less than the preset interval in a scenario image frame set as the pair of adjacent image frames;
extracting all matching feature pairs from the pair of adjacent image frames;
screening the extracted matching feature pairs according to a predetermined screening condition to obtain a target matching feature pair of the target plane object; and
calculating three-dimensional space coordinates of the target matching feature pair, and constructing the corresponding plane equation based on the three-dimensional space coordinates.

3. The method according to claim 2, wherein the screening the extracted matching feature pairs according to the predetermined screening condition to obtain the target matching feature pair of the target plane object, comprises:
deleting a matching feature pair meeting at least one of following conditions from the extracted matching feature pairs: not belonging to the target plane object, a reprojection error is less than a preset threshold condition, or not meeting homography; and
determining a remaining matching feature pair as the target matching feature pair.

4. The method according to claim 2, further comprising:
associating the graphic box to the corresponding plane equation; and
merging, in response to determining that a plurality of identical plane equations are associated to identical graphic boxes, the identical plane equations.

5. The method according to claim 4, further comprising:
acquiring respectively a number of the identical graphic boxes associated to each of the plane equations to obtain a number of association;
deleting a plane equation having the number of association not meeting a preset threshold requirement.

6. The method according to claim 1, wherein the merging, in response to existence of at least two identical plane equations, the at least two identical plane equations to obtain the target plane equation, comprises:
merging, in response to existence of at least two approximate plane equations pointing to a same plane at the same time, the approximate plane equations to obtain the only target plane equation.

7. The method according to claim 1, wherein the calculating to obtain real corner coordinates of the target plane object, based on corner theoretical coordinates of the graphic box on the plane corresponding to the target plane equation and gravity information of the target plane object, comprises:
determining reference line information on the plane corresponding to the target plane equation;
determining gravity information of the plane based on the reference line information; and
determining, after acquiring a horizontal projection of the plane, the real corner coordinates of the target plane object, based on the corner theoretical coordinates of the graphic box, the gravity information, and the horizontal projection.

8. An electronic device, comprising:
at least one processor; and
a memory, communicatively connected with the at least one processor;
the memory storing instructions executable by the at least one processor, and the instructions, when executed by the at least one processor, causing the at least one processor to perform operations, the operations comprising:
constructing a corresponding plane equation based on three-dimensional space coordinates of a matching feature pair of a target plane object included in a pair of adjacent image frames; the target plane object being framed by an identical graphic box in any frame of the adjacent image frames, and the pair of adjacent image frames being a pair of image frames having a frame interval less than a preset interval;
merging, in response to existence of at least two identical plane equations, the at least two identical plane equations to obtain a target plane equation; and
calculating to obtain real corner coordinates of the target plane object, based on corner theoretical coordinates of the graphic box on a plane corresponding to the target plane equation and gravity information of the target plane object.

9. The electronic device according to claim 8, wherein the constructing the corresponding plane equation based on three-dimensional space coordinates of the matching feature pair of the target plane object included in the pair of adjacent image frames, comprises:
determining the pair of image frames having the frame interval less than the preset interval in a scenario image frame set as the pair of adjacent image frames;
extracting all matching feature pairs from the pair of adjacent image frames;
screening the extracted matching feature pairs according to a predetermined screening condition to obtain a target matching feature pair of the target plane object; and
calculating three-dimensional space coordinates of the target matching feature pair, and constructing the corresponding plane equation based on the three-dimensional space coordinates.

10. The electronic device according to claim 9, wherein the screening the extracted matching feature pairs according to the predetermined screening condition to obtain the target matching feature pair of the target plane object, comprises:
deleting a matching feature pair meeting at least one of following conditions from the extracted matching feature pairs: not belonging to the target plane object, a reprojection error is less than a preset threshold condition, or not meeting homography; and
determining a remaining matching feature pair as the target matching feature pair.

11. The electronic device according to claim 9, the operations further comprising:
associating the graphic box to the corresponding plane equation; and
merging, in response to determining that a plurality of identical plane equations are associated to identical graphic boxes, the identical plane equations.

12. The electronic device according to claim 11, the operations further comprising:
acquiring respectively a number of the identical graphic boxes associated to each of the plane equations to obtain a number of association;
deleting a plane equation having the number of association not meeting a preset threshold requirement.

13. The electronic device according to claim 8, wherein the merging, in response to existence of at least two identical plane equations, the at least two identical plane equations to obtain the target plane equation, comprises:
merging, in response to existence of at least two approximate plane equations pointing to a same plane at the same time, the approximate plane equations to obtain the only target plane equation.

14. The electronic device according to claim 8, wherein the calculating to obtain real corner coordinates of the target plane object, based on corner theoretical coordinates of the graphic box on the plane corresponding to the target plane equation and gravity information of the target plane object, comprises:
determining reference line information on the plane corresponding to the target plane equation;
determining gravity information of the plane based on the reference line information; and
determining, after acquiring a horizontal projection of the plane, the real corner coordinates of the target plane object, based on the corner theoretical coordinates of the graphic box, the gravity information, and the horizontal projection.

15. A non-transitory computer readable storage medium, storing computer instructions, the computer instructions being used to cause a computer to perform operations, the operations comprising:
constructing a corresponding plane equation based on three-dimensional space coordinates of a matching feature pair of a target plane object included in a pair of adjacent image frames; the target plane object being framed by an identical graphic box in any frame of the adjacent image frames, and the pair of adjacent image frames being a pair of image frames having a frame interval less than a preset interval;
merging, in response to existence of at least two identical plane equations, the at least two identical plane equations to obtain a target plane equation; and
calculating to obtain real corner coordinates of the target plane object, based on corner theoretical coordinates of the graphic box on a plane corresponding to the target plane equation and gravity information of the target plane object.
